(19) United States
(12) Patent Application Publication
(10) Pub. No.: US 2018/0176386 A1
(43) Pub. Date: Jun. 21, 2018

(54) METHOD AND APPARATUS FOR SWITCHING MULTI-PARTY CALL, AND MULTI-CHANNEL TERMINAL

(71) Applicant: SPREADTRUM COMMUNICATIONS (SHANGHAI) CO., LTD., Shanghai (CN)

(72) Inventor: Minqian QIAN, Shanghai (CN)

(21) Appl. No.: 15/802,934

(22) Filed: Nov. 3, 2017

(30) Foreign Application Priority Data
Dec. 20, 2016 (CN) 201611184638.0

(51) Int. Cl. H04M 7/12; H04M 7/00; H04M 3/56; H04L 12/761

(52) U.S. Cl. CPC H04M 7/123; H04M 7/0057; H04M 2207/187; H04L 45/16; H04M 2203/5009; H04M 3/56

(57) ABSTRACT

A method and an apparatus for switching a multi-party call, and a terminal are provided. The method includes detecting whether a multi-party call realized on a current network side needs to be switched to a multi-party call realized on a terminal, or a multi-party call realized on a current terminal needs to be switched to a multi-party call realized on a network side; and the multi-party call realized on a terminal and the multi-party call realized on a network side can be switched to each other based on the detection result. Therefore, diversified requirements of scenes and users can be satisfied.

### CROSS-REFERENCE TO RELATED APPLICATIONS

The present invention claims priority under 35 U.S.C. § 119 to Chinese Application No. 201611184638.0, filed on Dec. 20, 2016, the entire content of which is incorporated herein by reference.

### TECHNICAL FIELD

The present disclosure relates to communication technology field, and more particularly, to a method and an apparatus for switching a multi-party call, and a multi-channel terminal.

### BACKGROUND

With continuous improvement of mobile network bandwidth and optimization of mobile device performance, user demands for services provided by mobile terminals also increase gradually. Currently, the mobile terminal business has become more and more diversified compared with a conventional call between two persons, for example, video calls, call forwarding and multi-party calls and other services have emerged in recent years. Existing multi-party calls are realized on terminals or network. In a multi-party call realized on a terminal, the terminal as a host party receives data of each participant, mixes sound at the local end and then sends the mixed sound to each participant; while in a multi-party call realized on network, the network receives data of each participant, mixes the sound at the network side and then sends the mixed sound to each participant.

Compared with the multi-party call realized on the terminal side, the multi-party call realized on the network side does not have a function of grouping the multi-party call and the network side can support a multi-party call with six-channels at most. There are often some application scenes, where a multi-party call realized on a terminal side needs to be switched to a multi-party call realized on a network side, for example, when a Single Radio Voice Call Continuity (SRVCC) switching happens to a host.

However, in a conventional technology, the multi-party call realized on the terminal side and the multi-party call realized on the network side cannot be switched to each other, therefore the conventional multi-party call cannot satisfy diversified requirements of scenes and users.

### SUMMARY

A method and an apparatus for switching a multi-party call, and a multi-channel terminal are provided according to embodiments, which can realize switching between a multi-party call realized on a terminal and a multi-party call realized on a network side, so as to meet diversified requirements of scenes and users.

A method for switching a multi-party call applied to a multi-channel terminal is provided according to embodiments of the present disclosure. The method may include: detecting whether a current multi-party call realized on a network side needs to be switched to a multi-party call realized on a terminal side, or a current multi-party call realized on a terminal side needs to be switched to a multi-party call realized on a network side; when it is detected that the current multi-party call realized on the network side needs to be switched to a multi-party call realized on a terminal side, switching the current multi-party call realized on the network side to a multi-party call realized on a terminal side or joining the current multi-party call realized on the network side to an existing multi-party call realized on a terminal side; and when it is detected that the current multi-party call realized on a terminal side needs to be switched to a multi-party call realized on the network side, switching the current multi-party call realized on the terminal side to a multi-party call realized on the network side or joining the current multi-party call realized on the terminal side to an existing multi-party call realized on the network side.

Optionally, switching the current multi-party call realized on the network side to a multi-party call realized on a terminal side or joining the current multi-party call realized on the network side to an existing multi-party call realized on a terminal side may include: maintaining the current multi-party call realized on the network side, and switching call ends in the current multi-party call realized on the network side to a newly established multi-party call realized on a terminal side, or joining the call ends in the current multi-party call realized on the network side to an existing multi-party call realized on a terminal side; and terminating the current multi-party call realized on the network side.

Optionally, switching the current multi-party call realized on the terminal side to a multi-party call realized on the network side or joining the current multi-party call realized on the terminal side to an existing multi-party call realized on a network side may include: maintaining the current multi-party call realized on the terminal side, and switching call ends in the current multi-party call realized on the terminal side to a newly established multi-party call realized on the network side or joining the call ends in the current multi-party call realized on the terminal side to an existing multi-party call realized on the network side; and terminating the current multi-party call realized on the terminal side.

Optionally, switching the call ends in the current multi-party call realized on the network side to a newly established multi-party call realized on a terminal side, or joining the call ends in the current multi-party call realized on the network side to an existing multi-party call realized on a terminal side may include: reestablishing a call with terminals of the call ends, and switching the call to the newly established multi-party call realized on the terminal side or joining the call to the existing multi-party call realized on the terminal side.

Optionally, switching the call ends in the current multi-party call realized on the terminal side to a newly established multi-party call realized on the network side or joining the call ends in the current multi-party call realized on the terminal side to an existing multi-party call realized on the network side may include: notifying the network side to switch terminals of the call ends in the current multi-party call realized on the terminal side to the newly established multi-party call realized on the network side, or notifying the network side to join the terminals of the call ends in the current multi-party call realized on the terminal side to the existing multi-party call realized on the network side.

Optionally, an apparatus for switching a multi-party call located in a multi-channel terminal is provided according to embodiments of the present disclosure. The apparatus may include: a detecting circuitry, configured to detect whether a current multi-party call realized on a network side needs to be switched to a multi-party call realized on a terminal side, or a current multi-party call realized on a terminal side needs to be switched to a multi-party call realized on a network side; a first switching circuitry, configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and a second switching circuitry, configured to switch the current multi-party call realized on the terminal side to a multi-party call realized on the network side or to join the current multi-party call realized on the terminal side to an existing multi-party call realized on the network side, when it is detected that the current multi-party call realized on the terminal side needs to be switched to a multi-party call realized on the network side.

Optionally, the first switching circuitry may include: a first switching sub circuitry, configured to maintain the current multi-party call realized on the network side, and to switch call ends in the current multi-party call realized on the network side to a newly established multi-party call realized on a terminal side, or to join the call ends in the current multi-party call realized on the network side to an existing multi-party call realized on a terminal side; and a first terminating sub circuitry, configured to terminate the current multi-party call realized on the network side.

Optionally, the second switching circuitry may include: a second switching sub circuitry, configured to maintain the current multi-party call realized on the terminal side, and to switch call ends in the current multi-party call realized on the terminal side to a newly established multi-party call realized on the network side or to add the call ends in the current multi-party call realized on the terminal side to an existing multi-party call realized on the network side; and a second terminating sub circuitry, configured to terminate the current multi-party call realized on the terminal side.

Optionally, the first switching sub circuitry is further configured to reestablish a call with terminals of the call ends, and to switch the call to a newly established multi-party call realized on a terminal side or to join the call to an existing multi-party call realized on a terminal side.

Optionally, the second switching sub circuitry is further configured to notify the network side to switch terminals of the call ends in the current multi-party call realized on the terminal side to a newly established multi-party call realized on the network side, or to notify the network side to add the terminals of the call ends in the current multi-party call realized on the terminal side to an existing multi-party call realized on the network side.

A multi-channel terminal including the aforementioned apparatus for switching a multi-party call is also provided according to embodiments of the present disclosure. The apparatus for switching a multi-party call may include: a detecting circuitry, configured to detect whether a current multi-party call realized on a network side needs to be switched to a multi-party call realized on a terminal side, or a current multi-party call realized on a terminal side needs to be switched to a multi-party call realized on a network side; a first switching circuitry, configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and a second switching circuitry, configured to switch the current multi-party call realized on the terminal side to a multi-party call realized on the network side or to join the current multi-party call realized on the terminal side to an existing multi-party call realized on the network side, when it is detected that the current multi-party call realized on the terminal side needs to be switched to a multi-party call realized on the network side.

In the method and apparatus for switching a multi-party call and the multi-channel terminal in the present disclosure, whether a current multi-party call realized on a network side needs to be switched to a multi-party call realized on a terminal side, or a current multi-party call realized on a terminal side needs to be switched to a multi-party call realized on a network side is detected; when it is detected that the current multi-party call realized on the network side needs to be switched to a multi-party call realized on a terminal side, the current multi-party call realized on the network side is switched to a multi-party call realized on a terminal side or joined to an existing multi-party call realized on a terminal side; and when it is detected that the current multi-party call realized on the terminal side needs to be switched to a multi-party call realized on the network side, the current multi-party call realized on the terminal side is switched to a multi-party call realized on a network side or joined to an existing multi-party call realized on the network side. Compared with a conventional technology, a multi-party call realized on a terminal side and a multi-party call realized on the network side can be switched to each other, so as to meet diversified requirements of scenes and users.

### BRIEF DESCRIPTION OF THE DRAWINGS

FIG. 1 schematically illustrates a flow chart of a method for switching a multi-party call according to an embodiment;

FIG. 2 schematically illustrates a flow chart of an apparatus for switching a multi-party call according to an embodiment;

FIG. 3 schematically illustrates a structural diagram of a first switching circuitry according to an embodiment; and

FIG. 4 schematically illustrates a structural diagram of a second switching circuitry according to an embodiment.

### DETAILED DESCRIPTION

In order to make the above-mentioned objects, features and advantages of the present disclosure more easily understood, specific embodiments of the present disclosure will be described in detail with reference to the accompanying drawings below. Apparently, embodiments described below are merely a portion of embodiments of the present disclosure, and are not all embodiments. All other embodiments obtained by those of ordinary skill in the art without making creative work are within the scope of the present disclosure, based on embodiments disclosed hereinafter.

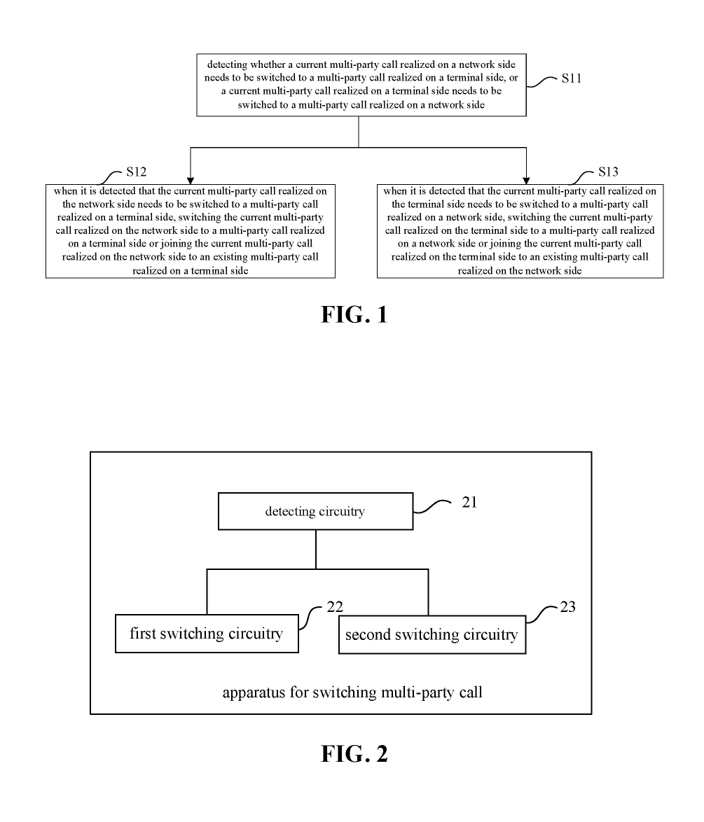

A method for switching a multi-party call applied to a multi-channel terminal is provided according to embodiments. Referring to FIG. 1, the method may include S11, S12 and S13.

In S11, whether a current multi-party call realized on a network side needs to be switched to a multi-party call realized on a terminal side, or a current multi-party call realized on a terminal side needs to be switched to a multi-party call realized on a network side is detected.

Specifically, the multi-party call realized on the network side refers to a call with more than two users participating simultaneously, and sound mixing of the call is performed on the network side; and the multi-party call realized on the terminal side refers to a call with more than two users participating simultaneously, and sound mixing of the call is performed on the terminal side. The multi-party call realized on the network side according to embodiments can be realized in a manner specified in a TS 24.147 protocol.

Further, in practical applications, detecting whether a current multi-party call realized on a network side needs to be switched to a multi-party call realized on a terminal side, or a current multi-party call realized on a terminal side needs to be switched to a multi-party call realized on a network side may include detecting whether a user made a switching request, and this method may be applied in some specific scenes that need switching. For example, a host party of the multi-party call realized on the terminal side cannot maintain the multi-party call realized on the terminal when a signal is poor and a Single Radio Voice Call Continuity (SRVCC) switching occurs, therefore, the multi-party call realized on the terminal side needs to be switched to a multi-party call realized on the network side in advance. In the scene where a SRVCC switching occurs, a threshold value indicating a poor detection signal may be preset, and the multi-party call realized on the terminal side needs to be switched to the multi-party call realized on the network side when the detected signal is less than the preset threshold value.

In S12, when it is detected that the current multi-party call realized on the network side needs to be switched to a multi-party call realized on a terminal side, the current multi-party call realized on the network side may be switched to a multi-party call realized on a terminal side or joined to an existing multi-party call realized on a terminal side.

In S13, when it is detected that the current multi-party call realized on the terminal side needs to be switched to a multi-party call realized on a network side, the current multi-party call realized on the terminal side may be switched to a multi-party call realized on the network side or joined to an existing multi-party call realized on the network side.

In the method for switching a multi-party call, whether a current multi-party call realized on the network side needs to be switched to a multi-party call realized on a terminal side, or a current multi-party call realized on a terminal side needs to be switched to a multi-party call realized on a network side is detected; when it is detected that the current multi-party call realized on the network side needs to be switched to the multi-party call realized on a terminal side, the current multi-party call realized on the network side is switched to a multi-party call realized on a terminal side or joined to an existing multi-party call realized on a terminal side; and when it is detected that the current multi-party call realized on the terminal side needs to be switched to a multi-party call realized on the network side, the current multi-party call realized on the terminal side is switched to a multi-party call realized on the network side or joined to an existing multi-party call realized on the network side. Compared with a conventional technology, the multi-party call realized on a terminal and the multi-party call realized on a network side can be switched to each other, so as to meet diversification requirements of scenes and users.

In some embodiments, switching the current multi-party call realized on the network side to a multi-party call realized on a terminal side or joining the current multi-party call realized on the network side to an existing multi-party call realized on a terminal side may include: maintaining the current multi-party call realized on the network side, and switching call ends in the current multi-party call realized on the network side to a newly established multi-party call realized on a terminal side, or adding the call ends in the current multi-party call realized on the network side to an existing multi-party call realized on a terminal side; and terminating the current multi-party call realized on the network side.

Specifically, switching the call ends in the current multi-party call realized on the network side to a newly established multi-party call realized on a terminal side, or adding the call ends in the current multi-party call realized on the network side to an existing multi-party call realized on a terminal side may include transmitting a Session Initiation Protocol (SIP) request message to the call ends to establish a new channel.

The method for switching a multi-party call will be described below in detail with reference to specific embodiments.

In some embodiment, a terminal A, a terminal B and a terminal C are making a multi-party call realized on a network side, where the terminal A is a host party; and meanwhile the terminal A, a terminal D, and a terminal E are making a multi-party call realized on a terminal side, where the terminal A is a host party as well, then the method for switching a multi-party call may include the following steps.

In a first step, it is detected that, the multi-party call realized on the network side needs to be joined to the existing multi-party call realized on the terminal side.

In a second step, the current multi-party call realized on the network side is maintained, and call ends in the current multi-party call realized on the network side are added to the existing multi-party call realized on the terminal side. Specifically, the terminal A reestablishes a call with terminals of the call ends, and joins the call to the existing multi-party call realized on the terminal side, and then a new multi-party call is formed among the terminal A, the terminal B, the terminal C, the terminal D and the terminal E.

In a third step, the current multi-party call realized on the network side among the terminal A, the terminal B and the terminal C is terminated.

In some embodiment, a terminal A, a terminal B and a terminal C are making a multi-party call realized on a network side, where the terminal A is a host party. The method for switching a multi-party call may include the following steps.

In a first step, it is detected that, the terminal A needs to switch the current multi-party call realized on the network side to a newly established multi-party call realized on a terminal side.

In a second step, the multi-party call realized on the current network side is maintained, and call ends in the multi-party call realized on the current network side are switched to a newly established multi-party call realized on a terminal side. Specifically, the terminal A reestablishes a call with terminals of the call ends, and switches the call to the newly established multi-party call realized on the terminal side.

In a third step, the current multi-party call realized on the network side among the terminal A, the terminal B and the terminal C is terminated.

In some embodiment, switching the current multi-party call realized on the terminal side to a multi-party call realized on a network side or joining the current multi-party call realized on the terminal side to an existing multi-party call realized on the network side may include: maintaining the current multi-party call realized on the terminal side, and switching call ends in the current multi-party call realized on the terminal side to a newly established multi-party call realized on the network side or adding the call ends in the current multi-party call realized on the terminal side to an existing multi-party call realized on the network side; and terminating the current multi-party call realized on the terminal side.

Specifically, switching call ends in the current multi-party call realized on the terminal side to a newly established multi-party call realized on the network side or adding the call ends in the current multi-party call realized on the terminal side to an existing multi-party call realized on the network side may be achieved via a REFER massage of SIP, for example, via establishing a Three-Way Session according to a TS 24.147 protocol.

The method for switching a multi-party call will be described below in detail with reference to specific embodiments.

In some embodiments, a terminal A, a terminal B and a terminal C are making a multi-party call realized on a terminal, where the terminal A is a host party. Signal of the terminal A is poor and a SRVCC switching occurs, then the terminal A cannot host the multi-party call realized on the terminal side. Therefore, the multi-party call realized on the terminal side needs to be switched to a multi-party call realized on a network side before the SRVCC switching; or the terminal A needs to switch the multi-party call realized on the terminal side to the multi-party call realized on a network side for other reasons. The method for switching a multi-party call may include the following steps.

In a first step, it is detected that, the terminal A needs to switch the multi-party call realized on the terminal to a multi-party call realized on a network side.

In a second step, the current multi-party call realized on the terminal side is maintained, and call ends in the current multi-party call realized on the terminal side are switched to a newly established multiparty call realized on a network side. Specifically, the terminal A may notify the network side to switch the call ends in the multi-party call realized on the terminal side to a newly established multi-party call in the network side.

In a third step, the multi-party call realized on the terminal side among the terminal A, the terminal B and the terminal C is terminated.

In some embodiments, a terminal A, a terminal B and a terminal C are making a multi-party call realized on a network side, where the terminal A is a host party; and meanwhile, the terminal A, a terminal D and a terminal E are making a multi-party call realized on a terminal side, where the terminal A is a host party. The method for switching a multi-party call may include the following steps.

In a first step, it is detected that, the terminal A needs to join the multi-party call realized on the terminal side to a multi-party call realized on a network side.

In a second step, the current multi-party call realized on the terminal side is maintained, and call ends in the current multi-party call realized on the terminal side are added to the existing multi-party call realized on the network side. Specifically, the terminal A may notify the network side to add the call ends in the current multi-party call realized on the terminal side to the existing multi-party call realized on the network side, and then a new multi-party call is formed among the terminal A, the terminal B, the terminal C, the terminal D and the terminal E.

In a third step, the multi-party call realized on the terminal side among the terminal A, the terminal D and the terminal E is terminated.

In some embodiments, switching the call ends in the current multi-party call realized on the network side to a newly established multi-party call realized on a terminal side, or adding the call ends in the current multi-party call realized on the network side to an existing multi-party call realized on the terminal side may include: reestablishing a call with terminals of the call ends, and switching the call to a newly established multi-party call realized on a terminal side or joining the call to an existing multi-party call realized on a terminal side.

In some embodiments, switching the call ends in the current multi-party call realized on the terminal side to a newly established multi-party call realized on the network side or adding the call ends in the current multi-party call realized on the terminal side to an existing multi-party call realized on the network side may include: notifying the network side to switch terminals of the call ends in the current multi-party call realized on the terminal side to a newly established multi-party call realized on the network side, or notifying the network side to add the terminals of the call ends in the current multi-party call realized on the terminal side to an existing multi-party call realized on the network side.

An apparatus for switching a multi-party call located in a multi-channel terminal is also provided according to embodiments.

Referring to FIG. 2, the apparatus includes a detecting circuitry 21, a first switching circuitry 22, and a second switching circuitry 23.

The detecting circuitry 21 is configured to detect whether a current multi-party call realized on a network side needs to be switched to a multi-party call realized on a terminal side, or a current multi-party call realized on a terminal side needs to be switched to a multi-party call realized on a network side.

The first switching circuitry 22 is configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side.

The second switching circuitry 23 is configured to switch the current multi-party call realized on the terminal side to a multi-party call realized on a network side or to join the current multi-party call realized on the terminal side to an existing multi-party call realized on a network side, when it is detected that the current multi-party call realized on the terminal side needs to be switched to a multi-party call realized on a network side.

The apparatus for switching a multi-party call is configured to detect whether a current multi-party call realized on a network side needs to be switched to a multi-party call realized on a terminal side, or a current multi-party call realized on a terminal side needs to be switched to a multi-party call realized on a network side; to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and to switch the current multi-party call realized on the terminal side to a multi-party call realized on a network side or to join the current multi-party call realized on the terminal side to an existing multi-party call realized on the network side, when it is detected that the current multi-party call realized on the terminal needs to be switched to a multi-party call realized on a network side. Compared with the conventional technology, the multi-party call realized on a terminal side and the multi-party call realized on a network side can be switched to each other, so as to meet diversified requirements of scenes and users.

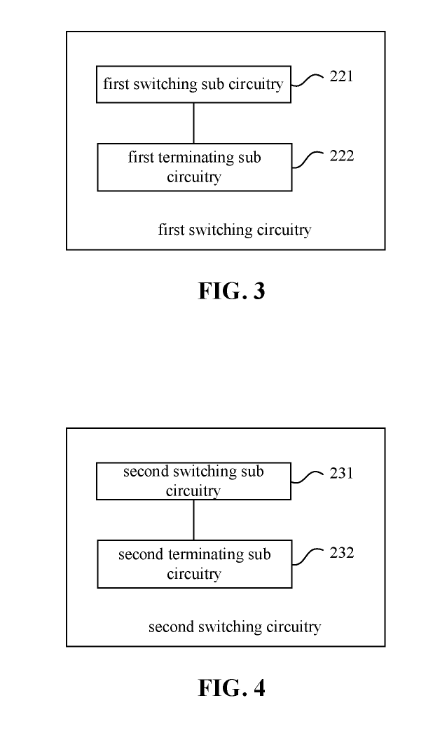

Referring to FIG. 3, in some embodiment, the first switching circuitry 22 may include a first switching sub circuitry 221, which is configured to maintain the current multi-party call realized on the network side, and to switch call ends in the current multi-party call realized on the network side to a newly established multi-party call realized on a terminal side, or to add the call ends in the current multi-party call realized on the network side to an existing multi-party call realized on a terminal side; and a first terminating sub circuitry 222, which is configured to terminate the current multi-party call realized on the network side.

Referring to FIG. 4, in some embodiments, the second switching circuitry 23 may include a second switching sub circuitry 231, configured to maintain the current multi-party call realized on the terminal side, and to switch call ends in the current multi-party call realized on the terminal side to a newly established multi-party call realized on a network side or to add the call ends in the current multi-party call realized on the terminal side to an existing multi-party call realized on a network side; and a second terminating sub circuitry 232, configured to terminate the current multi-party call realized on the terminal side.

In some embodiments, the first switching sub circuitry 221 is further configured to reestablish a call with terminals of the call ends, and to switch the call to a newly established multi-party call realized on a terminal side or to join the call to an existing multi-party call realized on a terminal side.

In some embodiments, the second switching sub circuitry 231 is further configured to notify the network side to switch terminals of the call ends in the current multi-party call realized on the terminal side to a newly established multi-party call realized on a network side, or to notify the network side to add the terminals of the call ends in the current multi-party call realized on the terminal side to an existing multi-party call realized on a network side.

A multi-channel terminal is also provided according to embodiments. The multi-channel terminal may include the aforementioned apparatus for switching a multi-party call. In some embodiments, the apparatus is located in a multi-channel terminal and includes: a detecting circuitry, configured to detect whether a current multi-party call realized on a network side needs to be switched to a multi-party call realized on a terminal side, or a current multi-party call realized on a terminal side needs to be switched to a multi-party call realized on a network side; a first switching circuitry, configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and a second switching circuitry, configured to switch the current multi-party call realized on the terminal side to a multi-party call realized on the network side or to join the current multi-party call realized on the terminal side to an existing multi-party call realized on the network side, when it is detected that the current multi-party call realized on the terminal side needs to be switched to a multi-party call realized on the network side.

It will be appreciated by those of ordinary skill in the art that all or a portion of the steps in the various methods of the embodiments described above may be performed by a program that instructs the associated hardware to be stored in a computer-readable storage medium which may include: ROM, RAM, magnetic disk, or optical disk.

Although the present disclosure has been described above, the present disclosure is not limited thereto. It should be understood by those skilled in the art that various changes and modifications may be made without departing from the spirit and scope of the disclosure, and therefore, the scope of the disclosure should be limited by the scope of the claims.

1. A method for switching a multi-party call, applied to a multi-channel terminal, comprising:
detecting whether a current multi-party call realized on a network side needs to be switched to a multi-party call realized on a terminal side, or a current multi-party call realized on a terminal side needs to be switched to a multi-party call realized on a network side;
when it is detected that the current multi-party call realized on the network side needs to be switched to a multi-party call realized on a terminal side, switching the current multi-party call realized on the network side to a multi-party call realized on a terminal side or joining the current multi-party call realized on the network side to an existing multi-party call realized on a terminal side; and
when it is detected that the current multi-party call realized on a terminal side needs to be switched to a multi-party call realized on the network side, switching the current multi-party call realized on the terminal side to a multi-party call realized on the network side or joining the current multi-party call realized on the terminal side to an existing multi-party call realized on the network side.

2. The method according to claim 1, wherein switching the current multi-party call realized on the network side to a multi-party call realized on a terminal side or joining the current multi-party call realized on the network side to an existing multi-party call realized on a terminal side comprises:
maintaining the current multi-party call realized on the network side, and switching call ends in the current multi-party call realized on the network side to a newly established multi-party call realized on a terminal side, or joining the call ends in the current multi-party call realized on the network side to an existing multi-party call realized on a terminal side; and
terminating the current multi-party call realized on the network side.

3. The method according to claim 1, wherein switching the current multi-party call realized on the terminal side to a multi-party call realized on the network side or joining the current multi-party call realized on the terminal side to an existing multi-party call realized on a network side comprises:
maintaining the current multi-party call realized on the terminal side, and switching call ends in the current multi-party call realized on the terminal side to a newly established multi-party call realized on the network side or joining the call ends in the current multi-party call realized on the terminal side to an existing multi-party call realized on the network side; and
terminating the current multi-party call realized on the terminal side.

4. The method according to claim 2, wherein switching the call ends in the current multi-party call realized on the network side to a newly established multi-party call realized on a terminal side, or joining the call ends in the current multi-party call realized on the network side to an existing multi-party call realized on a terminal side comprises:
reestablishing a call with terminals of the call ends, and switching the call to the newly established multi-party call realized on the terminal side or joining the call to the existing multi-party call realized on the terminal side.

5. The method according to claim 3, wherein switching the call ends in the current multi-party call realized on the terminal side to a newly established multi-party call realized on the network side or joining the call ends in the current multi-party call realized on the terminal side to an existing multi-party call realized on the network side comprises:
notifying the network side to switch terminals of the call ends in the current multi-party call realized on the terminal side to the newly established multi-party call realized on the network side, or notifying the network side to join the terminals of the call ends in the current multi-party call realized on the terminal side to the existing multi-party call realized on the network side.

6. An apparatus for switching a multi-party call, located in a multi-channel terminal, comprising:
a detecting circuitry, configured to detect whether a current multi-party call realized on a network side needs to be switched to a multi-party call realized on a terminal side, or a current multi-party call realized on a terminal side needs to be switched to a multi-party call realized on a network side;
a first switching circuitry, configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and
a second switching circuitry, configured to switch the current multi-party call realized on the terminal side to a multi-party call realized on the network side or to join the current multi-party call realized on the terminal side to an existing multi-party call realized on the network side, when it is detected that the current multi-party call realized on the terminal side needs to be switched to a multi-party call realized on the network side.

7. The apparatus according to claim 6, wherein the first switching circuitry comprises:
a first switching sub circuitry, configured to maintain the current multi-party call realized on the network side, and to switch call ends in the current multi-party call realized on the network side to a newly established multi-party call realized on a terminal side, or to join the call ends in the current multi-party call realized on the network side to an existing multi-party call realized on a terminal side; and
a first terminating sub circuitry, configured to terminate the current multi-party call realized on the network side.

8. The apparatus according to claim 6, wherein the second switching circuitry comprises:
a second switching sub circuitry, configured to maintain the current multi-party call realized on the terminal side, and to switch call ends in the current multi-party call realized on the terminal side to a newly established multi-party call realized on the network side or to add the call ends in the current multi-party call realized on the terminal side to an existing multi-party call realized on the network side; and
a second terminating sub circuitry, configured to terminate the current multi-party call realized on the terminal side.

9. The apparatus according to claim 7, wherein the first switching sub circuitry is further configured to reestablish a call with terminals of the call ends, and to switch the call to a newly established multi-party call realized on a terminal side or to join the call to an existing multi-party call realized on a terminal side.

10. The apparatus according to claim 8, wherein the second switching sub circuitry is further configured to notify the network side to switch terminals of the call ends in the current multi-party call realized on the terminal side to a newly established multi-party call realized on the network side, or to notify the network side to add the terminals of the call ends in the current multi-party call realized on the terminal side to an existing multi-party call realized on the network side.

11. A multi-channel terminal, comprising: an apparatus for switching a multi-party call that is located in a multi-channel terminal;
wherein the apparatus for switching a multi-party call comprises:
a detecting circuitry, configured to detect whether a current multi-party call realized on a network side needs to be switched to a multi-party call realized on a terminal side, or a current multi-party call realized on a terminal side needs to be switched to a multi-party call realized on a network side;
a first switching circuitry, configured to switch the current multi-party call realized on the network side to a multi-party call realized on a terminal side or to join the current multi-party call realized on the network side to an existing multi-party call realized on a terminal side, when it is detected that the current multi-party call realized on the network side needs to be switched to a multi-party call realized on a terminal side; and
a second switching circuitry, configured to switch the current multi-party call realized on the terminal side to a multi-party call realized on the network side or to join the current multi-party call realized on the terminal side to an existing multi-party call realized on the network side, when it is detected that the current multi-party call realized on the terminal side needs to be switched to a multi-party call realized on the network side.
